(19) United States
(12) Patent Application Publication
(10) Pub. No.: US 2005/0135992 A1
(43) Pub. Date: Jun. 23, 2005

(54) Superox process for increasing processing capacity of sulfur recovery facilities

(75) Inventor: Thomas King Tong Chow, Villa Park, CA (US)

Correspondence Address: David T. Bracken;The Law Office of David T. Bracken, 4839 Bond Avenue, Orange, CA, 92869, US

(73) Assignee: Parsons Parsons Energy & Chemicals Group, Inc.

(21) Appl. No.: 10/959,678

(22) Filed: Oct. 4, 2004

Related U.S. Application Data
(63) Continuation of application No. 09/596,892, filed on Jun. 19, 2000, now abandoned.

(51) Int. Cl. C01B 17/04

(52) U.S. Cl. 423/574.1

(57) ABSTRACT

The present invention is a method to expand sulfur processing capacity for a new or existing sulfur recovery unit. In one embodiment, the method includes passing a process gas stream containing sulfur dioxide over a catalyst capable of oxidation of sulfur dioxide in one or more catalytic stages upstream of a tailgas treatment unit.

This is a continuation in part of Ser. No. 09/596,892 filed Jun. 19, 2000.

### BACKGROUND OF THE INVENTION

The present invention relates to a process for obtaining elemental sulfur from gas comprising hydrogen sulfide and optionally sulfur dioxide. The present invention also relates to retrofitting existing sulfur recovery units for greater than about 25% increase in sulfur recovery.

The most commonly used process for recovering elemental sulfur from a gas containing hydrogen sulfide and optionally sulfur dioxide is the modified Claus process. The modified Claus process typically consists of a thermal step and one or more catalytic steps separated by condensation, phase separation and reheating steps.

In a well known method for practicing the modified Claus process, an acid gas feed comprising at least more than about 30 mole percent hydrogen sulfide mixed with a process air stream, the mixture being ignited to form an open flame or flames within a furnace. About one third of the hydrogen sulfide in the acid gas feed which is not converted to elemental sulfur in the furnace is thermally oxidized with the oxygen in the process air stream to form sulfur dioxide in the same molar amount as the oxidized hydrogen sulfide, according to the following oxidation reaction:
Oxidation Reaction: H₂S+3/2 O₂<-->SO₂+H₂O

It is known that substantial conversion via the Claus or other reactions within the furnace converts the hydrogen sulfide and sulfur dioxide therein to elemental sulfur and that up to 60% of hydrogen sulfide in an acid gas feed entering such a furnace may be converted therein to elemental sulfur. Thus, calculation of heat release from oxidation of hydrogen sulfide to sulfur dioxide is a highly complex calculation and depends on several important factors such as hydrogen sulfide and oxygen concentrations and the presence of substantial amounts of hydrocarbons or ammonia. Ammonia is known to comprise a substantial portion of acid gas feed streams in some circumstances.

The partially oxidized furnace effluent is cooled, partially condensed, and the gas phase is separated from condensed sulfur and reheated. The reheated gas is fed to a catalyst bed, which then catalyzes the reaction between hydrogen sulfide and SO₂ to form elemental sulfur according to the following Claus reaction:
Claus Reaction: 2H₂S+SO₂<-->3/n Sₙ+2H₂O

The use of air in this reaction introduces a relatively large volume of nitrogen into the gas tight hydraulic sequence beginning at the furnace, continuing through the equipment of the condensation and catalytic steps, and typically and finally passing through the equipment of a tail gas treatment step. The nitrogen is not removed from the process gas in the equipment sequence and thus forces a designer to provide a substantial conduit cross section for passage of the nitrogen of the process gas to reduce pressure drop through the equipment.

During the past 10-15 years, pure oxygen or oxygen enriched air has been used instead of process air with the acid gas feed in the thermal stage. The costs of nitrogen reduction in oxygen enriched gas for use in the thermal stage and its associated equipment has proven in many circumstances overwhelmingly less expensive than using process air. The idea is to eliminate or minimize the nitrogen to preserve hydraulic capacity for more sulfur processing.

Burners in the thermal stage are specifically engineered to accomplish the thermal stage reaction in a pressurized combustion flame enclosed in a relatively short refractory lined space. Many common Claus air burners must operate only with oxygen enriched air with less than or equal to 28 mole percent oxygen. Use of 28% oxygen enriched air in a thermal stage would allow the processing capacity of a Claus sulfur recovery unit designed for air operation to be expanded for an additional 25% as compared with substantially the same unit using air in the thermal stage. This operation is usually referred to as low level oxygen enrichment process. Required capital investment for implementation of the technology is usually insignificant, although per ton operating costs increase for purchase of or processing to obtain enriched air.

For capacity expansion beyond 25% of the original air operation capacity, a different type of burner, referred to as an oxygen burner, must be used designed specifically for high temperatures and mixing the reduced relative gas volumes while obtaining a substantially complete oxidation reaction in the thermal stage. High density refractory lined, gas tight metal pressure vessels used for the furnace are generally limited to a refractory design temperature of about 3,000° F. in thermal stage operation.

Unfortunately, even after using such an oxygen burner, the thermal stage temperature will reach the temperature limits, where the acid gas feed is primarily hydrogen sulfide, using about 45 mole percent oxygen enriched air in a single thermal stage. Use of 45% oxygen enriched air would enable the processing capacity of a Claus sulfur recovery unit designed for air operation to be expanded for approximately an additional 70% as in the preceding comparison. This operation is usually referred to as medium level oxygen enrichment process. The oxygen burner and oxygen management control system are required for medium level oxygen enrichment, which add to the cost of the process.

For capacity expansion beyond 70% of the original air operation capacity, the Parsons/BOC process known in the art as the SURE Double Combustion and Air Products' process known in the art as the COPE use different methods to use enriched air at higher levels than 45 mole percent oxygen. The Parsons/BOC process requires an additional reaction furnace/waste heat boiler. The Air Products' process requires acid gas recycle operation with an acid gas recycle blower and a new reaction furnace/waste heat boiler. These processes are capable of achieving up to 2.5 times of the original unit design capacity. This capacity expansion of from 70% to 150% is known as the high level oxygen enrichment process. These processes require much higher capital investment and operating costs compared to the medium level oxygen enrichment process.

Tail gas treatment methods exist in the prior art for conversion of low levels of sulfur moieties to elemental sulfur or to capture and recycle them to the sulfur recovery unit. One of the tail gas treating processes, which increases the overall sulfur recovery from a conventional Claus unit, is the BSR/Selectox process. In this process, the Claus tail gas is first heated to a desired reaction temperature required in the BSR hydrogenation/hydrolysis catalytic reactor. Typically, a reducing gas generator (RGG) is used to heat the tail gas and provide additional hydrogen by incomplete oxidation of a hydrocarbon feed in the RGG. Sulfur species in the tail gas, such as elemental sulfur, sulfur dioxide, COS and CS₂, are converted to hydrogen sulfide in a hydrogenation/hydrolysis reactor. After the hydrogenation step, the excess water in this gas is reduced by condensation. The gas is then processed in the selective oxidation catalyst reactor for sulfur recovery. The selective oxidation catalyst catalyzes the oxidation of hydrogen sulfide to sulfur dioxide in the presence of oxygen. The Claus reaction for the production of elemental sulfur from hydrogen sulfide also occurs over the process gas passage over the selective oxidation catalyst.

A stoichiometric amount of oxygen is added to the process gas passing through the selective oxidation catalyst reactor resulting in an effluent from that reactor having an hydrogen sulfide:sulfur dioxide ratio of 2:1 for a subsequent Claus reaction in a subsequent Claus catalyst reactor stage. Overall sulfur recovery for Claus units equipped with BSR/Selectox unit can be up to 99 percent process.

If even higher sulfur recovery is desired, the selective oxidation reaction step is removed and the converted-species sulfur in the form of hydrogen sulfide issuing from the hydrogenation/hydrolysis reactor is absorbed in an absorber using an hydrogen sulfide-selective amine process, such as MDEA. The removed hydrogen sulfide is recycled to the Claus thermal stage for enhanced sulfur recovery. This process, known as BSR/MDEA or SCOT, can improve overall sulfur recovery to more than 99.9%. However, the additional capital cost for the BSR type tail gas processes can be more than 50% of a conventional Claus unit because of the additional hydrogenation, water removal and the tail gas cleanup steps.

Another method to increase overall sulfur recovery for a modified Claus process is to use a selective oxidation catalyst stage as the last stage in which elemental sulfur is formed from non-elemental sulfur components in the tail gas. In a catalytic Claus stage, thermodynamic equilibrium limits the conversion of hydrogen sulfide and sulfur dioxide to sulfur. However, direct oxidation of hydrogen sulfide to elemental sulfur is essentially complete in a direct oxidation catalyst stage and is not so limited. A tail gas stage with direct oxidation catalyst results in higher overall sulfur recovery compared to a process using only catalytic Claus stages. The direct oxidation reaction is expressed as:
H₂S+½0₂-->1/n Sₙ+H₂O

One of the commercial processes that use the final direct oxidation stage is the SuperClaus process. The SuperClaus process uses an hydrogen sulfide-shifted Claus operation (higher hydrogen sulfide: sulfur dioxide ratio than 2:1 effluent from the thermal stage) followed by one or more Claus stages, followed with a direct oxidation step. The SuperClaus consists of a thermal stage followed by two or three Claus stages and one final selective oxidation stage. The thermal stage and the Claus catalytic stages are operated under an hydrogen sulfide-shifted Claus operation, either by reducing the combustion air to the main burner of the thermal stage or by-passing a portion of the Claus feed gas around the main burner, in order to minimize the residual sulfur dioxide in the gas leaving the last Claus stage since any residual sulfur dioxide entering the direct oxidation catalyst stage will not be substantially converted to elemental sulfur. In a shifted ratio operation using direct oxidation catalyst to treat a tail gas, the effluent of the last Claus catalyst reactor (the penultimate reactor for the unit) is a tail gas low in non-elemental sulfur components. That tail gas has an hydrogen sulfide:sulfur dioxide ratio of greater than 2:1, instead of the typical hydrogen sulfide:sulfur dioxide ratio to 2:1 for a tail gas from a conventional Claus unit. The direct oxidation catalyst employed is substantially insensitive to the presence of water vapor in the process gas and ineffective in promoting a reverse Claus reaction. The overall sulfur recovery for the SuperClaus process can be more than 99%, depending on the feed gas composition and the number of catalytic stages. By eliminating the hydrogenation step and the water removal step, as required by the BSR/Selectox process, BSR/MDEA or SCOT process, the additional capital cost for substituting a SuperClaus stage for a 3rd Claus stage in a three catalytic stage sulfur recovery unit is claimed to be 15-20% higher than the Claus unit. However, operating the thermal stage and the Claus stages at higher hydrogen sulfide:sulfur dioxide ratio reduces the overall sulfur recovery efficiency of the front-end section of the process which results in a shift of the sulfur recovery load to the final selective oxidation stage. Due to normal plant fluctuations in acid gas feed composition and process conditions, the last catalytic oxidation stage (with direct oxidation) can be subjected to high hydrogen sulfide feed and subsequent temperature excursion, which may require reactor bypass or plant shutdown.

Another process combines BSR hydrogenation of the above described sulfur compounds and the selective oxidation of hydrogen sulfide to elemental sulfur, eliminating the hydrogen sulfide-shifted Claus operation as required in the SuperClaus process. This process, represented in actual operation as the BSR Hi-Activity and the SuperClaus 99.5 processes, can obtain up to 99.5% overall sulfur recovery. These processes are less expensive than the other types of BSR tail gas cleanup processes, because no water removal step is required.

Although the unskilled may view the variety of Claus-combined sulfur conversion processes as easily understood, in fact sulfur plant operation is a very complicated and challenging job. Acid gas feed to a sulfur plant usually includes wide variation in the volume and concentration of sulfur and other compounds, including a substantial amount of ammonia or amine in some plants. Theoretically, control of the thermal stage(s) using air, enriched air or oxygen for conversion of hydrogen sulfide to sulfur dioxide has permitted some processes to obtain extremely high recovery of sulfur whether for the 2:1 ratio for hydrogen sulfide to sulfur dioxide or for hydrogen sulfide-shifted operation. In actual operation, the several interactions of stream component analysis and measurement of flow, temperature, pressure and other process parameters with the compressors, valves, burners, aging or fouled catalyst beds and other process equipment has made error-free, continuous recovery of sulfur from acid gas an elusive goal.

U.S. Pat. No. 6,214,311, directed at sulfur dioxide reduction, describes a process in which oxidation is used in a tail gas treatment step. It is well known that

### BRIEF DESCRIPTION OF THE DRAWINGS

FIG. 1 is a process flow sheet of a prior art sulfur recovery unit using a single thermal stage and three sequential Claus catalytic stages.

FIG. 2 is a process flow sheet of the invention sulfur recovery unit comprising a single thermal stage, two sequential selective oxidation catalytic stages, and a final Claus catalytic stage.

FIG. 3 is a process flow sheet of the invention sulfur recovery unit comprising a single thermal stage, two sequential selective oxidation catalytic stages, an sulfur dioxide reduction catalytic stage, and final catalytic stage using Parsons' Hi-Activity catalyst for oxidation of hydrogen sulfide to elemental sulfur.

FIG. 3A shows an alternate embodiment of the process shown in FIG. 3.

FIG. 4 is a process flow sheet for increased capacity of parallel Claus sulfur recovery units.

### SUMMARY OF THE INVENTION

The present invention comprises a novel method to expand sulfur processing capacity for a new or existing sulfur recovery unit. Selective oxidation catalyst is used instead of Claus reaction catalyst, the expanded capacity being potentially equal to medium to high level oxygen enrichment processes wherein major equipment types, sizes and costs are substantially the same as that of a conventional modified Claus process unit using air in the thermal stage. Thus, the invention process comprises methods for retrofits of existing sulfur recovery units having been designed for processes not including selective oxidation in a catalyst bed between a thermal or first oxidation stage (as is typical of lean acid gas plants) and the tail gas treatment stage or upstream of a tail gas from that existing sulfur recovery unit. Tail gas treatment stages typically act on process streams having preferably less than about 15 to about 0.1 mole percent of non-elemental sulfur components in the process stream, but more preferably when that level drops to about 5 to 0.5 mole percent of non-elemental sulfur components in the process stream. The prior art fails to suggest that such mid-positions for selective oxidation catalyst beds in a sulfur recovery unit, i.e. those positions after a first stage (thermal or oxidation) and a final stage (processing a tail gas of 15 to 0.1 mole percent of non-elemental sulfur components in the process stream).

The invention method in one embodiment comprises equipment with at least a single thermal stage comprising a furnace with a standard or specially designed oxygen burner, a first high temperature heat exchanger and a thermal stage condenser/separator, where the thermal stage is followed by two or more catalytic stages. As used herein, a catalytic stage comprises (including connecting conduits, temperature control bypasses, and control valves) a heating means, such as reheating exchanger or direct reheating burner, non-elemental sulfur component catalytic conversion in one or more immediately sequential catalyst beds in a pressure vessel or substantially adiabatic series of process steps, and a condenser/separator having means for removing condensed elemental sulfur from the process stream.

In an alternate embodiment, it is known in the art that for low acid gas (lean) feeds comprising low hydrogen sulfide (trace to about 30 mole percent), the single thermal stage and its associated condenser/separator may be replaced with prior art equipment and processes for catalytic oxidation followed by condenser/separator having means for removing condensed elemental sulfur from the process stream. As yet another alternative, the single thermal stage may be replaced with dual or multiple thermal stages as shown and described in U.S. Pat. No. 5,294,428.

For the present invention method, the above prior art selective oxidation catalyst (such as Selectox® catalyst of UOP) comprises at least part of the catalyst in at least one of the catalytic stages prior to sulfur recovery from a tail gas as described above. Tail gas in the prior art has comprised from about 15 mole percent to barely detectable non-elemental sulfur components.

In one embodiment of the invention process, an acid gas feed is substantially reacted in a first thermal or oxidation stage according to the above prior art methods, wherein elemental sulfur is cooled and partly condensed in an associated condenser/separator, the effluent of which is a first process gas. In a first catalytic stage, oxygen in an oxygen containing gas (as used herein, oxygen is in molar concentration from about 21 to 100 mole percent) is mixed with a re-heated first process gas, whereafter the mixed stream is passed through one or more immediately sequential catalyst beds such that oxygen in the mixed stream reacts with the hydrogen sulfide therein to form sulfur dioxide over selective oxidation catalyst bed(s) effluent then being passed to the associated condenser/separator.

It is known in the art that the oxidation reaction of hydrogen sulfide in the presence of selective oxidation catalyst is a highly exothermic reaction whereby local temperatures on the catalyst and the pressure vessel wall and catalyst support equipment for beds of such catalyst may exceed permitted limits for safety and/or long life for such catalyst and equipment. These limits are known to the skilled person and depend on resistivity of catalyst and equipment to high temperature degradation. The relative molar amount and total amount of oxygen in the oxygen containing gas mixed with the thermal stage effluent is limited by these upper temperature limits. However, the invention method is intended to be practiced within an effective range of relative molar amounts and total amounts of oxygen in the oxygen containing gas mixed with the thermal stage effluent, wherein such range is from a trace amount of oxygen to pure oxygen, more preferably using oxygen concentration as in air to pure oxygen.

In the present invention, the catalyst(s) in the catalyst bed(s) of the mid-location catalytic stages that contain any selective oxidation catalyst are, as alternate embodiments, (1) only selective oxidation catalyst, (2) a first catalyst bed containing only selective oxidation catalyst and followed by a second catalyst bed of Claus reaction catalyst or other catalyst as described herein (such as catalyst for hydrogenation of sulfur dioxide to hydrogen sulfide where the mixed stream further comprises hydrogen or catalyst for direct reduction of sulfur dioxide to elemental sulfur where the mixed stream further comprises hydrogen or other reducing gas), or (3) a first catalyst bed of Claus reaction catalyst or other catalyst as described herein (such as catalyst for hydrogenation of sulfur dioxide to hydrogen sulfide where the mixed stream further comprises hydrogen or catalyst for direct reduction of sulfur dioxide to elemental sulfur where the mixed stream further comprises hydrogen or other reducing gas) and followed by a second catalyst bed containing only selective oxidation catalyst. So long as one of the mid-location catalytic stages is a catalytic stage that contains any selective oxidation catalyst and operated in the invention method, the other mid-location catalytic stages may contain only catalyst bed(s) of Claus reaction catalyst or other catalyst as described herein (such as catalyst for hydrogenation of sulfur dioxide to hydrogen sulfide where the mixed stream further comprises hydrogen or catalyst for direct reduction of sulfur dioxide to elemental sulfur where the mixed stream further comprises hydrogen or other reducing gas) or sequential beds thereof as just described for the sequential combination of selective oxidation catalyst bed with a bed of different catalyst.

For one invention embodiment, a second catalytic stage may comprise catalyst beds containing only Claus reaction catalyst or selective oxidation catalyst further converts sulfur moieties of the effluent gas of the first catalytic stage, whereby, if needed for reaction over selective oxidation catalyst, additional oxygen containing gas is mixed with such effluent prior to reaction over such selective oxidation catalyst. In another embodiment of the present invention, the catalyst bed of the first and/or second catalytic stage comprises a bed of selective oxidation catalyst preceded or succeeded immediately by a bed of Claus reaction catalyst.

Where the first and second catalytic stages comprise catalyst bed(s) with only selective oxidation catalyst, it is preferred that a third catalytic stage comprise catalyst bed(s) with only Claus reaction catalyst processing the gas effluent of the second catalytic stage. A fourth or fifth catalytic stage are alternatively used to process gas effluent of the third or fourth catalytic stages respectively. To obtain the benefits of the present invention, the catalyst beds of any of the mid-location catalytic stages may comprise selective oxidation catalyst.

It is well known in the art that the phrase “off-ratio” process refers to a sulfur recovery process on a process gas having an hydrogen sulfide:sulfur dioxide molar ratio of effectively greater or less than 2:1 so that the Claus reaction of that process gas is not optimal at converting those components to elemental sulfur. Sometimes the “off-ratio” process gas is intentionally obtained from an upstream process or the typical wide swings in delivery of acid gas to a sulfur recovery unit cause control fluctuations that unavoidably cause at least some “off-ratio” process gas production. The present invention using selective oxidation in a mid-location catalytic stage is intended (1) to react hydrogen sulfide in an off-ratio process gas to restore the effluent gas ratio to “on-ratio”, (2) to change its hydrogen sulfide:sulfur dioxide ratio from greater than 2:1 to, in the effluent gas ratio, some amount less than but still greater than 2:1, (3) to change its hydrogen sulfide:sulfur dioxide ratio from greater than 2:1 to, in the effluent gas ratio, some amount less than 2:1, or (4) to change its hydrogen sulfide:sulfur dioxide ratio from less than 2:1 to, in the effluent gas ratio, some amount less than the original ratio and also therefore less than 2:1. The present invention using selective oxidation in a mid-location catalytic stage is also intended to react hydrogen sulfide in an on-ratio process gas to, in the effluent gas ratio, some amount less than 2:1.

It is well known in the art that a final stage of catalytic or chemical reaction and/or sulfur moiety capture is/are used for “tail gas” treatment prior to atmospheric release of primarily non-sulfur components of the process gas. The present invention may be easily adapted to any of such prior art methods for tail gas treatment. The present invention departs from the prior art in permitting operation of the thermal stage at temperature limits with oxygen containing gas whereby the effluent gas of the thermal stage has a ratio of hydrogen sulfide to sulfur dioxide greater than 2:1 such that the process gas in the sulfur recovery unit obtains a ratio of hydrogen sulfide to sulfur dioxide of about 2:1 upstream of a catalytic stage consisting of Claus reaction catalyst, the change in the ratio of hydrogen sulfide to sulfur dioxide coming about as a result of oxidation reaction of hydrogen sulfide with oxygen over selective oxidation catalyst. Whereas the prior art required a first and second thermal stage as in U.S. Pat. No. 5,294,428 or recycle of a portion of the process gas to obtain the highest level of capacity expansion through oxygen enrichment of the oxygen containing gas reacted in the thermal stage, the present invention shifts the prior art oxidation load from the thermal stage to a catalytic stage downstream of thermal stage and thereby avoiding the temperature excesses necessitated by such a level of oxygen enrichment.

In another embodiment of the present invention, a thermal stage and first and second catalytic stages operate as above with selective oxidation catalyst in the first and second catalytic stages. The resulting gas effluent of the second catalytic stage may have a ratio of hydrogen sulfide to sulfur dioxide at or substantially lower than 2:1, although operation at a ratio close to 2:1 is generally preferable. The catalyst of the third catalytic stage comprises a novel sulfur dioxide reduction catalyst as described in U.S. patent application Ser. No. 09/157,467 filed Sep. 21, 1998, now issued as U.S. Pat. No. 6,214,311 B1, which disclosure is incorporated herein. The sulfur dioxide reduction catalyst of that application is capable concurrently of the Claus reaction and reduction of sulfur dioxide directly to elemental sulfur in the presence of a reducing gas such as CO or H₂ generated in the thermal stage or an inline burner operating at substoichiometric levels. Processing of the gas effluent of the second stage over sulfur dioxide reduction catalyst reduces sulfur moieties in the process gas to very low levels. A tail gas treatment of the gas effluent of the third catalytic stage is preferred, such within a final catalytic stage using Parsons Hi-Activity selective oxidation catalyst.

As described in U.S. Pat. No. 5,294,428, incorporated herein by reference, it is known that acid gas feed of approximately 60-100 mole percent hydrogen sulfide mixed solely with an oxygen containing gas of about 20-100 mole percent oxygen can result in temperatures in a single thermal stage furnace which exceeds permitted temperatures where 33% of the hydrogen sulfide is combusted to form sulfur dioxide. There is within these ranges of hydrogen sulfide and oxygen content a continuous range of limits calculable with prior art methods to determine maximum allowable oxygen content permitted for the oxygen containing gas such that one third of the hydrogen sulfide in the acid gas feed is combusted to sulfur dioxide. Although the present invention provides a method whereby a single thermal stage may be used without the Parsons/BOC, Air Products or similar prior art methods to obtain sulfur recovery equal to medium to high level oxygen enrichment processes with major equipment type, size and cost substantially the same as that of a standard modified Claus process unit using air in the thermal stage, such processes may prior art processes may be combined with the present invention to obtain a benefit thereby.

### DETAILED DESCRIPTION OF THE INVENTION

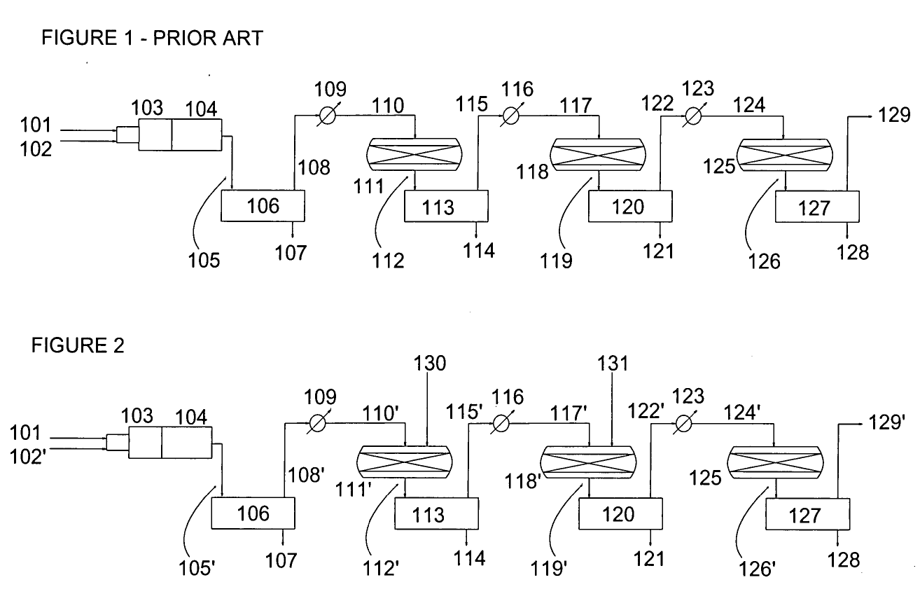

The invention is now discussed with reference to the Figures. Item numbers having the “prime” designation (as in stream 102 as opposed to stream 102′) identify those streams and catalyst beds in catalyst pressure vessels which change in relation to an expansion of sulfur recovery capacity in relation to the prior art process and equipment as shown in FIG. 1, whereby the prime designation of streams indicates a change in the ratio of hydrogen sulfide to sulfur dioxide in relation to the prior art Claus catalyst sulfur recovery unit.

FIG. 1 is a prior art sulfur recovery unit comprising generally a standard Claus furnace burner and furnace 103 associated with exchanger 104 and condenser/separator exchanger 106, the combination thereof comprising generally a single thermal stage. Reheater exchangers 109, 116 and 123, catalyst bed reactors 111, 118, and 125 and condenser/separator exchangers 113, 120 and 127 generally comprise, respectively, first, second and third catalytic stages.

The prior art method of sulfur recovery in FIG. 1 comprises an acid gas feed 101 (which may contain a substantial amount of NH₃) comprising more than about 30 mole percent hydrogen sulfide and process air stream 102, the two streams being combined and combusted under pressure in furnace 103 and cooled to about less than 750° F. in exchanger 104. The gas stream 105 is partly condensed in exchanger 106, wherein condensed sulfur is removed as stream 107. An thermal stage effluent separated gas stream 108 is reheated in exchanger 109 to form stream 110, which is fed to reactor 111 containing a bed of Claus reaction catalyst. Reactor effluent stream 112 is processed in two more catalytic stages. Stream 112 is partly condensed in exchanger 113, wherein condensed sulfur is removed as stream 114. An effluent separated gas stream 115 is reheated in exchanger 116 to form stream 117, which is fed to reactor 118 containing a bed of Claus reaction catalyst. Reactor effluent stream 119 is processed in one more catalytic stage. Stream 119 is partly condensed in exchanger 120, wherein condensed sulfur is removed as stream 121. An effluent separated gas stream 122 is reheated in exchanger 123 to form stream 124, which is fed to reactor 125 containing a bed of Claus reaction catalyst. Reactor effluent stream 126 is further condensed and separated in exchanger 127, forming liquid sulfur stream 128 and gas effluent stream 129. Stream 129 still comprises substantially more sulfur components than may be safely release to atmosphere and is preferably further treated with one of the tail gas treatment methods prior to such release.

The invention process embodiment of FIG. 2 comprises substantially the same equipment as that of FIG. 1, although with different catalyst in the catalytic stages. In a first embodiment of the invention, stream 102′ is an oxygen enriched stream comprising from about 26-28 mole percent oxygen and the burner of the furnace 103 comprises a burner designed for air combustion. The first thermal stage is operated such that the highest temperature limit for such a thermal stage is usually not attained. The degree of conversion of hydrogen sulfide to sulfur dioxide in the thermal stage is preferably designed so that the effluent of the thermal stage has a ratio hydrogen sulfide to sulfur dioxide of greater than 2:1 only to the extent that such a ratio may be reduced to about 2:1 in subsequent catalytic stages using selective oxidation catalyst. In this first embodiment, stream 105′ is hydrogen sulfide shifted upward from the 2:1 ratio and fed to exchanger 106, producing the separated gas stream 108′. Stream 108′ is reheated in exchanger 109 to form stream 110′ and mixed with pure oxygen stream 130 (which may optionally be an oxygen containing gas). Reactor 111′ contains selective oxidation catalyst, whereover some Claus reaction takes place but primarily all the oxygen of stream 130 reacts with hydrogen sulfide for form sulfur dioxide, the effluent forming stream 112′. Stream 112′ is partly condensed in exchanger 113 and the separated gas stream 115′ comprises significantly reduced ratio of hydrogen sulfide to sulfur dioxide as compared to stream 108′, although higher than 2:1. The equipment numbers are repeated in FIGS. 1 and 2 indicating that the present invention comprises a method of retrofitting an existing plant with the invention processes.

For the first embodiment, stream 115′ is reheated in exchanger 116 to form stream 117′ and mixed with pure oxygen stream 131 (which may optionally be an oxygen containing gas). Reactor 118′ contains selective oxidation catalyst, whereover some Claus reaction takes place but primarily all the oxygen of stream 131 reacts with hydrogen sulfide for form sulfur dioxide, the effluent forming stream 119′. Stream 119′ is partly condensed in exchanger 120 and the separated gas stream 122′ comprises a ratio of hydrogen sulfide to sulfur dioxide at about 2:1. This stream 122 is processed substantially the same as in the process of FIG. 1.

The substantial shift of oxidation from the thermal stage to the catalytic stages in this first embodiment results in a maximum capacity expansion as compared with the process of FIG. 1 of about 25 to 40 percent increased capacity for a comparable acid gas feed and major equipment set, depending on the hydrogen sulfide content of the acid gas feed and existing equipment sizing, in the case of a retrofit.

In a second embodiment of the present invention also as shown in FIG. 2, the burner of furnace 103 is replaced with a high oxygen burner, thereby permitting the use of an oxygen containing stream of up to 100 mole percent oxygen and thereby allowing for operation of the furnace at the operating temperature limit. The operation of the rest of the process is as in the first embodiment, with appropriate adjustments for oxygen flow to the stages 111′ and 118′. The increased conversion of hydrogen sulfide to sulfur dioxide in this second embodiment thereby increases the overall conversion of sulfur in the sulfur recovery unit to from 70 to 100 percent increased capacity for a comparable acid gas feed and major equipment set, depending on the hydrogen sulfide content of the acid gas feed and existing equipment sizing, in the case of a retrofit. With the extent of hydrogen sulfide oxidation to sulfur dioxide limited by operating temperatures in the catalytic stage reactors, it is intended that more than two successive catalytic stages may be provided with selective oxidation catalyst to obtain an effluent gas with a desirably reduced ratio of hydrogen sulfide to sulfur dioxide. It is an alternate embodiment that a catalytic stage with Claus reaction catalyst be provided between successive catalytic stages of selective oxidation catalyst, thereby reducing required oxidation of hydrogen sulfide to sulfur dioxide for a downstream catalytic stage with Claus reaction catalyst.

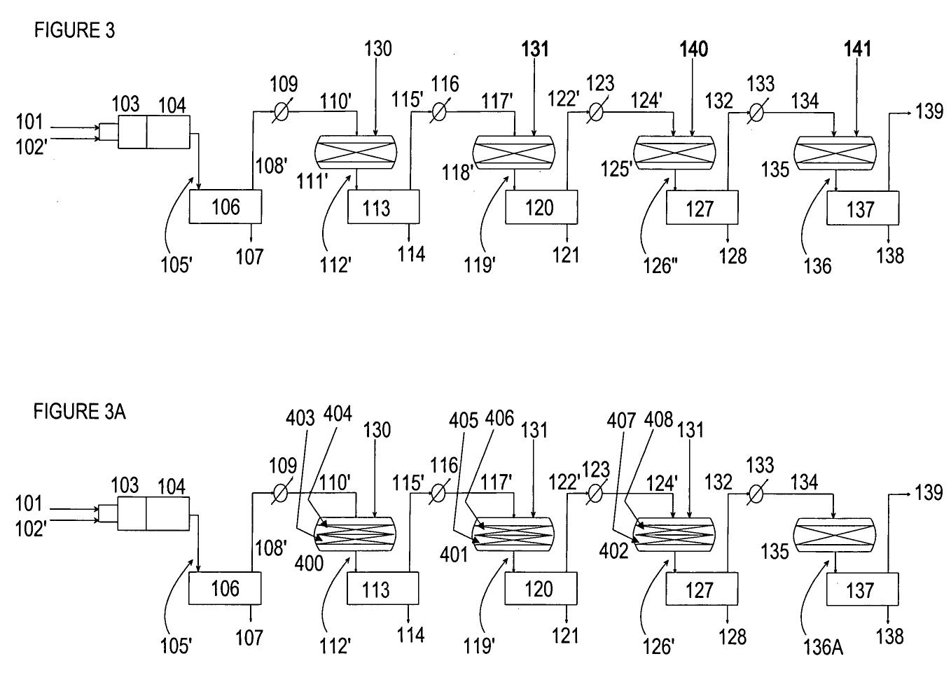

In a third and fourth embodiment of the present invention, FIG. 3 shows a process substantially as, respectively, the first and second embodiments of the invention as to the thermal stage and the first and second catalytic stages, although the ratio of hydrogen sulfide to sulfur dioxide of stream 119′ is substantially below 2:1 and may be below 1:1, although a ratio of close to 2:1 is generally preferred. Stream 119′ is processed in an sulfur dioxide reduction catalytic stage, as disclosed in copending Ser. No. 09/157,467 filed Sep. 21, 1998, which issued as U.S. Pat. No. 6,214,311 B1, which is incorporated herein. Stream 119′ in FIG. 3A is partly condensed and separated in exchanger 120 to form stream 122′, which is reheated in exchanger 123 and mixed with reducing gas 140, comprising H₂ and/or CO, and fed to reactor 125′ having an sulfur dioxide reduction catalyst therein. The effluent stream 126″ of reactor 125′ is very low in sulfur dioxide and comprises mostly hydrogen sulfide. Stream 126″ is partly condensed and separated in exchanger 127 to form stream 132, which is reheated in exchanger 133 and mixed with oxygen containing gas 141 and fed to reactor 135 having a Parsons' Hi-Activity catalyst therein. Stream 136 is partly condensed and separated in exchanger 137 to form liquid sulfur stream 138 and gas 139. Effluent stream 139 comprises extremely low levels of sulfur moieties and may with efficient operation be released to atmosphere in some locations.

The operation of the process of the third embodiment results in overall sulfur recovery from the acid gas feed of processing capacity expansion from 25 to 40 percent and sulfur recovery efficiency of greater than 99%.

The operation of the process of the fourth embodiment results in overall sulfur recovery from the acid gas feed of processing capacity expansion from 70 to 100 percent and sulfur recovery efficiency of greater than 99%.

The invention of FIG. 3A comprises an alternate embodiment of that shown in FIG. 3. It is intended to show generally that one or more of mid-location catalytic stages having, separately, beds 400, 401 or 402 may comprise two (or more) immediately adiabatically sequential catalyst beds. As used herein, mid-location as regards a catalytic stage refers to a location after a first thermal or oxidation stage and a tail gas treatment step to which a process gas is fed in which non-elemental sulfur components are generally less than about 10 mole percent of the process gas, more preferably about 5 mole percent, and least preferably 1-2 mole percent, where the process gas composition is likely to be subject to a tail gas treatment step. In addition, excepting the use of selective oxidation catalysts in a mid-location position, the prior art describes using other catalysts in a mid-location catalytic stage in a sulfur recovery unit. It is intended that FIG. 3A representations of two (or more) immediately adiabatically sequential catalyst beds of a catalytic stage also include one or more separated catalyst beds where the invention mid-locations for selective oxidation catalyst and one or more of those other prior art catalysts are simply mixed together in an appropriate ratio to obtain a desired result. For example, a selective oxidation catalyst can be mixed with Claus reaction catalyst to form a mixed bed.

For FIG. 3A, beds 404 and 403 receive in sequence the effluent of the thermal or oxidation stage (shown as steps 103, 104 and 106) after receiving in mixture therewith an oxygen containing gas 103. Beds 403 and 404 contain, in alternate, either the selective oxidation catalyst of the invention or one of the other catalysts described herein for sulfur conversion, i.e., Claus reaction catalyst, sulfur dioxide reduction catalyst or hydrogenation catalyst. Thus, in one embodiment of a multiple bed mid-location catalytic stage, beds 404, 406, and/or 408 contain only selective oxidation catalyst while beds 403, 405, and/or 407 contain only one of the other catalysts, vice versa, or as a mixed bed. In the overall embodiment of FIG. 3A, it is intended that one or more of other catalyst beds, either in separated catalyst beds or mixed with other catalyst(s), contain sufficient Claus reaction catalyst such that a separate catalytic stage with only Claus reaction catalyst is unnecessary to obtain the same overall reaction result as that shown in FIG. 2. The stream numbers of FIG. 3A are as those of FIG. 2, although the skilled person will observe that the feed and effluent gas compositions will have substantially different relative reaction ratios than those streams shown and described in FIG. 2 depending on the type and relative amounts of two or more catalysts adiabatically within beds 400, 401 and 402. Stream 131′ is another oxygen containing stream as stream 131.

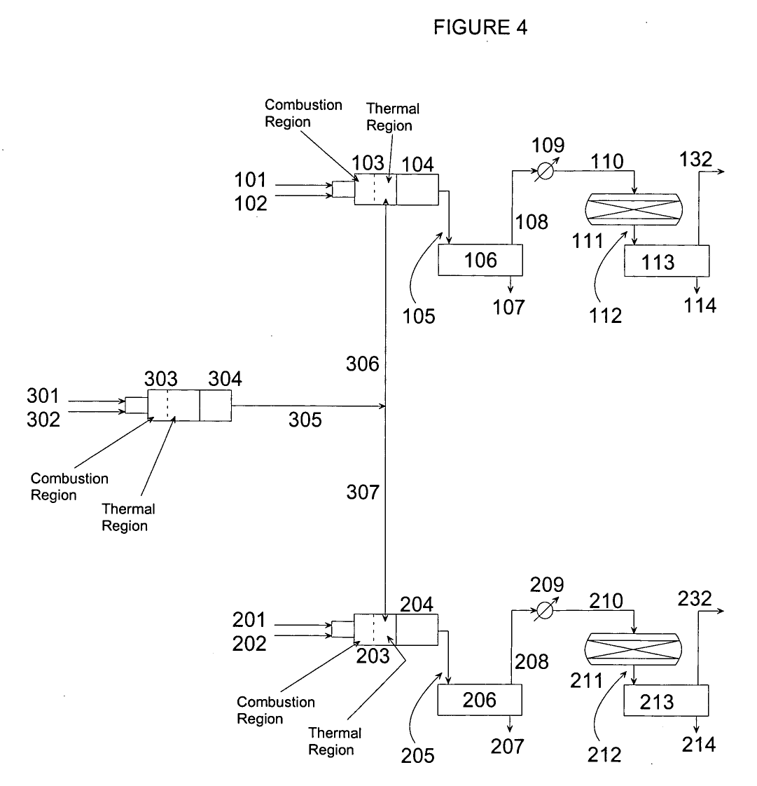

A novel process shown in FIG. 4 is now discussed with reference to U.S. Pat. No. 5,294,428, which is incorporated herein. At the top of FIG. 4 are shown the first process steps of a first Claus sulfur recovery unit, comprising a furnace 103, cooling exchanger 104, condenser 106 and a downstream catalytic stage 111. At the bottom of FIG. 4 are shown the first process steps of a second Claus sulfur recovery unit, having reference numbers analogous to those of the first Claus sulfur recovery unit increased by 100, i.e., acid gas feed stream 101 in the first Claus sulfur recovery unit is analogous to acid gas feed stream 201 in the second Claus sulfur recovery unit. Each of the furnaces 103, 203 and 303 comprise a noted combustion region and thermal region as in U.S. Pat. No. 5,294,428.

The process of FIG. 4 comprises substantially the process of U.S. Pat. No. 5,294,428, whereby furnace 303 reacts a feed gas stream 301 with a stream 302 of substantially pure oxygen as in the first combustion and thermal stages of that patent. A cooling heat exchanger 304 reduces the temperature of the effluent of furnace 303 to form stream 305. Stream 305 is split to form streams 306 and 307. Streams 306 and 307 are fed to the thermal regions of furnaces 103 and 203 respectively to accomplish a partial quench of the reactions therein as well as to further react the components of streams 306 and 307 to elemental sulfur, thereby in part performing the process of the second combustion and thermal regions of U.S. Pat. No. 5,294,428, albeit in parallel units and without condensation between the combustion regions as required in U.S. Pat. No. 5,294,428.

The invention of FIG. 4 comprises the ability to increase capacity of existing or initial design parallel train Claus sulfur recovery units via partial use of the process of U.S. Pat. No. 5,294,428 without a sulfur extraction step between the first and second combustion regions. A retrofit of existing parallel train Claus sulfur recovery units may be accomplished with the process of FIG. 4 with the capacity increases and with the stream compositions described in U.S. Pat. No. 5,294,428 while reducing the need for parallel and separate first combustion regions. The invention process also recognizes that the sulfur extraction (condensation) step at sulfur condenser 12 of U.S. Pat. No. 5,294,428 may be eliminated thereby surprisingly eliminating the equipment cost without causing substantial equipment redesign. Such elimination of sulfur condenser 12 was not contemplated by the disclosure of U.S. Pat. No. 5,294,428 or combinations of the prior art therewith.

Table 1 comprises a specific example of the operation of the process of FIG. 4, where streams 101 and 201 contain about 20% of the total hydrogen sulfide processed thereby and stream 301 contains the balance of the hydrogen sulfide so processed. Furnace 303 is operated with pure oxygen such that an off-ratio WHB effluent stream 305 is generated, having an hydrogen sulfide:sulfur dioxide ratio of about 12:1. The molar ratio of acid gas components in the cooling streams 306 and 307 to the acid gas components in the acid gas feeds 101 and 201 in the first and second Claus sulfur recovery units is about 1.8 to 2 to 1. The WHB effluent streams 105 and 205 have an hydrogen sulfide:sulfur dioxide ratio of about 2:1 as preferred for the Claus process. The present specific example demonstrates that a preferred mode of operation in a retrofit is to provide a substantial furnace 303 and WHB 304 to deliver a stream at sufficiently high temperature so no sulfur condenses in the transfer lines and sufficiently high so that the direct quench in the thermal regions of furnaces 103 and 203 does not substantially affect continuing conversion to elemental sulfur from thermal effects. Introducing the substantial amounts of elemental sulfur in streams 306 and 307 into the thermal regions provides substantial quenching effects due to the consequential rise in sensible temperature of the mass of streams 306 and 307.

The above design disclosures present the skilled person with considerable and wide ranges from which to choose appropriate obvious modifications for the above examples. However, the objects of the present invention will still be obtained by the skilled person applying such design disclosures in an appropriate manner.

| | Stream | | | | | | | | | | | |
|---|---|---|---|---|---|---|---|---|---|---|---|---|
| | 301 | 302 | 306 | 307 | 101 | 102 | 103A | 105 | 201 | 202 | 203A | 205 |
| | Description | | | | | | | | | | | |
| | Acid | | Gas to | Gas to | Acid | | | WHB | Acid | | | WHB |
| Composition | Gas | Oxygen | Train 1 | Train 2 | Gas | Air | Oxygen | Effluent | Gas | Air | Oxygen | Effluent |
| hydrogen | 807.32 | | 165.16 | 165.16 | 96.17 | | | 171.49 | 96.17 | | | 171.49 |
| sulfide | | | | | | | | | | | | |
| sulfur dioxide | | | 14.20 | 14.20 | | | | 86.01 | | | | 86.01 |
| H₂O | 148.52 | | 366.86 | 366.86 | 6.77 | 10.78 | | 488.57 | 6.77 | 10.78 | | 488.57 |
| O₂ | | 329.46 | | | | 73.19 | 52.33 | | | 73.19 | 52.33 | |
| N₂ | | | 24.67 | 24.67 | | 275.35 | | 300.01 | | 275.35 | | 300.01 |
| S₂ | | | 2.10 | 2.10 | | | | 0.68 | | | | 0.68 |
| S₄ | | | 0.12 | 0.12 | | | | 0.05 | | | | 0.05 |
| S₆ | | | 27.05 | 27.05 | | | | 25.90 | | | | 25.90 |
| S₈ | | | 7.12 | 7.12 | | | | 10.64 | | | | 10.64 |
| CO₂ | 20.92 | | 13.50 | 13.50 | 2.84 | | | 18.54 | 2.84 | | | 18.54 |
| H₂ | | | 30.77 | 30.77 | | | | 18.58 | | | | 18.58 |
| CO | | | 2.03 | 2.03 | | | | 1.02 | | | | 1.02 |
| COS | | | 0.36 | 0.36 | | | | 0.24 | | | | 0.24 |
| CS₂ | | | | | | | | | | | | |
| NH₃ | 98.68 | | | | | | | | | | | |
| Hydrocarbon | 10.86 | | | | 1.07 | | | | 1.07 | | | |
| TOTAL, | 1086.30 | 329.46 | 653.93 | 653.93 | 106.85 | 359.32 | 52.33 | 1121.73 | 106.85 | 359.32 | 52.33 | 1121.73 |
| lbmol/hr | | | | | | | | | | | | |
| Mass Flow, | 32966 | 10543 | 21755 | 21755 | 3542 | 10250 | 1675 | 37220 | 3542 | 10250 | 1675 | 37220 |
| lb/hr | | | | | | | | | | | | |
| Molecular | 30.35 | 32.00 | 33.27 | 33.27 | 33.15 | 28.53 | 32.00 | 33.18 | 33.15 | 28.53 | 32.00 | 33.18 |
| Weight | | | | | | | | | | | | |
| Temperature, | 137 | 200 | 750 | 750 | 120 | 200 | 90 | 650 | 120 | 200 | 90 | 650 |
| ° F. | | | | | | | | | | | | |
| Pressure, psia | 26.7 | 26.7 | 23.5 | 23.5 | 26.7 | 26.7 | 26.7 | 23.0 | 26.7 | 26.7 | 26.7 | 23.0 |

1. A process for sulfur recovery from acid gas comprising hydrogen sulfide where burners for one or more thermal stages of the sulfur recovery unit are adapted to burn the acid gas with a first oxygen containing gas, partly condensing liquid sulfur in a first condenser from a thermal stage effluent stream, and re-heating a cooled effluent gas from the first condenser to form a first feed stream, the improvement comprising:
(a) mixing the first feed stream with a second oxygen containing stream, the combined stream being fed to a first catalytic stage containing selective oxidation catalyst so that oxygen in the second oxygen containing stream is substantially entirely oxidized to form sulfur dioxide and elemental sulfur is formed in the first catalytic stage;
(b) cooling an effluent from the first catalytic stage for partial condensation of elemental sulfur in a second condenser and re-heating a gas effluent from the second condenser to form a second feed stream;
(b) feeding the second feed stream to a second catalytic stage containing catalyst adapted to convert hydrogen sulfide and sulfur dioxide to elemental sulfur so that elemental sulfur is formed in the second catalytic stage; and
(c) cooling an effluent from the second catalytic stage for partial condensation of elemental sulfur in a third condenser and re-heating a gas effluent from the third condenser to form a third feed stream.

2. The process of claim 1 wherein the first oxygen containing gas is limited by operating temperature limits of the thermal stages to contain less than or equal to about 28 mole percent oxygen.

3. The process of claim 1 wherein the first oxygen containing gas contains from 28 mole percent oxygen to 100 mole percent oxygen.

4. The process of claim 1 wherein the first catalytic stage has a single catalyst bed containing only selective oxidation catalyst.

5. The process of claim 1 wherein the first catalytic stage contains two or more adiabatically sequential catalyst beds, at least one of the sequential catalyst beds containing selective oxidation catalyst.

6. The process of claim 1 wherein the second feed stream is mixed with a third oxygen containing stream, the combined stream being fed to the second catalytic stage containing selective oxidation catalyst so that oxygen in the third oxygen containing stream is substantially entirely oxidized to form sulfur dioxide and elemental sulfur is formed in the second catalytic stage.

7. The process of claim 1 wherein the catalyst in the second catalytic stage is entirely Claus reaction catalyst.

8. A process for sulfur recovery from acid gas comprising hydrogen sulfide where burners for one or more thermal stages of the sulfur recovery unit are adapted to burn the acid gas with a first oxygen containing gas, partly condensing liquid sulfur in a first condenser from a thermal stage effluent stream, and re-heating a cooled effluent gas from the first condenser to form a first feed stream, the improvement comprising:
(a) feeding the first feed stream to a first catalytic stage containing catalyst adapted to convert hydrogen sulfide and sulfur dioxide to elemental sulfur so that elemental sulfur is formed in the first catalytic stage;
(b) cooling an effluent from the first catalytic stage for partial condensation of elemental sulfur in a second condenser and re-heating a gas effluent from the second condenser to form a second feed stream;
(b) mixing the second feed stream with a second oxygen containing stream, the combined stream being fed to a second catalytic stage containing selective oxidation catalyst so that oxygen in the second oxygen containing stream is substantially entirely oxidized to form sulfur dioxide and elemental sulfur is formed in the second catalytic stage; and
(c) cooling an effluent from the second catalytic stage for partial condensation of elemental sulfur in a third condenser and re-heating a gas effluent from the third condenser to form a third feed stream.

9. The process of claim 1 wherein the first oxygen containing gas is limited by operating temperature limits of the thermal stages to contain less than or equal to about 28 mole percent oxygen.

10. The process of claim 1 wherein the first oxygen containing gas contains from 28 mole percent oxygen to 100 mole percent oxygen.

11. The process of claim 1 wherein the catalyst in the first catalytic stage is entirely Claus reaction catalyst.

12. The process of claim 1 wherein the second catalytic stage contains two or more adiabatically sequential catalyst beds, at least one of the sequential catalyst beds containing selective oxidation catalyst.

13. The process of claim 1 wherein the first feed stream is mixed with a third oxygen containing stream, the combined stream being fed to the first catalytic stage containing selective oxidation catalyst so that oxygen in the third oxygen containing stream is substantially entirely oxidized to form sulfur dioxide and elemental sulfur is formed in the first catalytic stage.

14. The process of claim 1 wherein the second catalytic stage has a single catalyst bed containing only selective oxidation catalyst.

15. A process for retrofit of a unit for sulfur recovery from acid gas comprising hydrogen sulfide where the unit comprises one or more thermal stages adapted to burn the acid gas with an oxygen containing gas and two or more catalytic stages containing only Claus reaction catalyst so that the catalytic stages sequentially receive at least a part of the first feed stream to form elemental sulfur, the improvement comprising:
(a) replacing Claus reaction catalyst in a first, second or third sequential catalytic stage with selective oxidation catalyst; and
(b) operating the unit so that effluent from the third sequential catalytic stage comprises 2 mole percent or more hydrogen sulfide and sulfur dioxide combined.

16. The process of claim 15 wherein an original design capacity for the unit for sulfur recovery unit is increased about from 70 percent to about 100 percent for the same acid gases.

17. The process of claim 15 wherein the effluent from the third sequential catalytic stage comprises 10 mole percent or more hydrogen sulfide and sulfur dioxide combined.

18. The process of claim 15 wherein the effluent from the third sequential catalytic stage comprises 10 mole percent or more hydrogen sulfide and sulfur dioxide combined.
